(19) United States
(12) Patent Application Publication
(10) Pub. No.: US 2025/0125453 A1
(43) Pub. Date: Apr. 17, 2025

(54) Power Transmission Unit, Method for Controlling Current, Fuel Cell System and Medium

(71) Applicant: Robert Bosch GmbH, Stuttgart (DE)

(72) Inventors: Zhao Yan, Suzhou (CN); Guangtu Zhang, Suzhou (CN); Dongsheng Chen, Shanghai (CN)

(21) Appl. No.: 18/910,928

(22) Filed: Oct. 9, 2024

(30) Foreign Application Priority Data
Oct. 12, 2023 (CN) 2023 1132 3519.9

(51) Int. Cl. H01M 16/00; H01M 8/04858

(52) U.S. Cl. CPC H01M 16/006; H01M 8/0488; H01M 8/04888; H01M 8/0491

(57) ABSTRACT

A power transmission unit and a method for controlling the current flowing through it are disclosed. The power transmission unit includes a first switch which is turned on and off at a first duty cycle; a second switch which is turned on and off at a second duty cycle that is less than the first duty cycle; an inductive element connected between the first switch and the second switch, with its current associated with the first and second duty cycles; and a controller configured to determine a total duty cycle as the sum of the first and second duty cycles based on an actual phase current and a desired phase current of the inductive element, and to adjust the first and second duty cycles based on the determined total duty cycle. Embodiments of the present disclosure adjust both the first and second duty cycles through the total duty cycle, which changes with the total duty cycle, allowing both the first and second duty cycles to be adjusted to appropriate values. This ensures that the current flowing through the inductive element reaches an appropriate value, thereby enabling small current control.

This application claims priority under 35 U.S.C. § 119 to patent application no. CN 2023 1132 3519.9, filed on Oct. 12, 2023 in China, the disclosure of which is incorporated herein by reference in its entirety.

The examples of the present disclosure generally relate to the field of power transmission, specifically to a power transmission unit, a method for controlling the current of the power transmission unit, a fuel cell system, and a machine-readable storage medium.

### BACKGROUND

For a fuel cell power system, the Power Transmission Unit (PTU) is used to transmit electrical energy from the fuel cell power system (e.g., a fuel cell stack) to a power battery (e.g., a high-voltage battery (HV battery)). If a fuel cell engine is used for a hybrid vehicle, where the number of batteries typically exceeds 400, there is an overlap between the output voltage of the fuel cell and the voltage of the high-voltage battery. Therefore, the PTU usually supports buck-boost mode, boost mode, and buck mode to achieve stable current control.

If the PTU operates in Buck-Boost mode, a non-complementary buck-boost control method is used to reduce the phase current ripple of the PTU and decrease the phase inductance value. Therefore, it is necessary to further enhance or improve this non-complementary buck-boost control method.

### SUMMARY

The examples of the present disclosure provide a power transmission unit, a method for controlling the current of the power transmission unit, a fuel cell system, and a machine-readable storage medium.

According to a first aspect of the present disclosure, a power transmission unit for transmitting the electromotive force of a fuel cell stack to a power battery is provided. The power transmission unit includes: a first switch, configured to turn on and off at a first duty cycle; a second switch configured to turn on and off at a second duty cycle less than the first duty cycle; an inductive element connected between the first switch and the second switch, through which a current flows that is associated with the first and second duty cycles; and a controller configured to determine a total duty cycle as the sum of the first and second duty cycles based on the actual phase current and the desired phase current of the inductive element, and to adjust the first and second duty cycles based on the determined total duty cycle.

According to a second aspect of the present disclosure, a method for controlling the current of a power transmission unit is provided. The power transmission unit is used to transmit the electromotive force of a fuel cell stack to a power battery and includes: a first switch, configured to turn on and off at a first duty cycle; a second switch configured to turn on and off at a second duty cycle; and an inductive element connected between the first switch and the second switch, through which a current flows that is associated with the first duty cycle and the second duty cycle. The method includes: obtaining a desired phase current for the inductive element; obtaining the actual phase current flowing through the inductive element; determining a total duty cycle as the sum of the first and second duty cycles based on the desired phase current and the actual phase current; adjusting the first and second duty cycles based on the total duty cycle; and controlling the turning on and off of the first switch based on the adjusted first duty cycle and controlling the turning on and off of the second switch based on the adjusted second duty cycle to control the current flowing through the inductive element.

According to a third aspect of the present disclosure, a fuel cell system is provided. The fuel cell system includes: a fuel cell stack; a power battery; and the power transmission unit according to the first aspect of the present disclosure, configured to transmit the electromotive force of the fuel cell stack to the power battery.

According to a fourth aspect of the present disclosure, a machine-readable storage medium is provided. The machine-readable storage medium stores machine-executable instructions, which, when executed by a processor, implement the steps of the method according to the second aspect of the present disclosure.

### BRIEF DESCRIPTION OF THE DRAWINGS

The exemplary examples of the present disclosure will be described in further detail in conjunction with accompanying drawings in order to further clarify the above-mentioned and other objectives, features and advantages of the present disclosure, wherein in the exemplary examples of the present disclosure, the same reference number typically represents the same parts.

FIG. 1A illustrates a schematic diagram of the connection relationship between the power transmission unit, fuel cell stack, and power battery according to an example of the present disclosure;

FIG. 1B illustrates a schematic diagram of the current flow direction and a current waveform diagram when the power transmission unit operates in a buck-boost mode according to an example of the present disclosure;

FIG. 2 illustrates a trend diagram of the instantaneous current of the inductor in continuous current mode (CCM) (solid line) and discontinuous current mode (DCM) (dashed line) according to an example of the present disclosure;

FIG. 3 illustrates a schematic diagram of the structure of the controller of the power transmission unit according to an example of the present disclosure;

FIG. 4 illustrates a trend diagram of the instantaneous current on the inductor in a buck-boost mode when Vin is greater than Vout according to an example of the present disclosure;

FIG. 5 illustrates a trend diagram of the instantaneous current on the inductor in a buck-boost mode when Vin is less than Vout according to an example of the present disclosure;

FIG. 6 illustrates a flowchart of a method for controlling the current of the power transmission unit according to an example of the present disclosure; and

FIG. 7 illustrates a schematic block diagram of an example apparatus implementing an example of the present disclosure.

In the various accompanying drawings, the same or corresponding numbers represent the same or corresponding portions.

### DETAILED DESCRIPTION

The examples of the present disclosure will be described in further detail below with reference to the accompanying drawings. While certain examples of the present disclosure are shown in the accompanying drawings, it should be understood that the present disclosure may be implemented in various forms and should not be construed as being limited to the examples set forth herein, rather these examples are provided for a more thorough and complete understanding of the present disclosure. It should be understood that the accompanying drawings and examples of the present disclosure are for exemplary purposes only and are not intended to limit the scope of protection of the present disclosure. The examples of the present disclosure described below with reference to the accompanying drawings are for exemplary purposes only.

As described above, the Power Transmission Unit (PTU) is connected between the fuel cell stack and the power battery to transmit electrical energy from the fuel cell power system to the power battery. The control unit of the fuel cell stack often issues small current control commands, such as battery control commands for currents less than 20 A. These small current control commands require that the current through components included in the PTU (e.g., the inductive element) also reach small current values (e.g., the average current over one cycle). However, due to the influence of the duty cycle of various switches included in the PTU (e.g., MOSFETs, NMOS, or PMOS), it often occurs that the current through the inductive element is relatively large, resulting in an average current over one cycle that is much greater than the small current indicated by the control unit of the fuel cell stack. This is particularly problematic when the PTU operates in a buck-boost mode, thus failing to achieve the small current control indicated by the control unit.

To address at least the above and other potential issues, examples of the present disclosure provide a power transmission unit capable of achieving small current control. The power transmission unit includes a first switch, configured to turn on and off at a first duty cycle; a second switch configured to turn on and off at a second duty cycle less than the first duty cycle; an inductive element connected between the first switch and the second switch, through which a current flows that is associated with the first and second duty cycles; and a controller configured to determine a total duty cycle as the sum of the first and second duty cycles based on the actual phase current and the desired phase current of the inductive element, and to adjust the first and second duty cycles based on the determined total duty cycle. By adjusting both the first and second duty cycles based on the total duty cycle, the first and second duty cycles will vary with changes in the total duty cycle, allowing both the first and second duty cycles to be adjusted to appropriate values. This ensures that the current flowing through the inductive element reaches an appropriate value. Therefore, when the stack control unit issues a small current control command, stable small current control can be achieved by continuously adjusting the first and second duty cycles based on the determined total duty cycle.

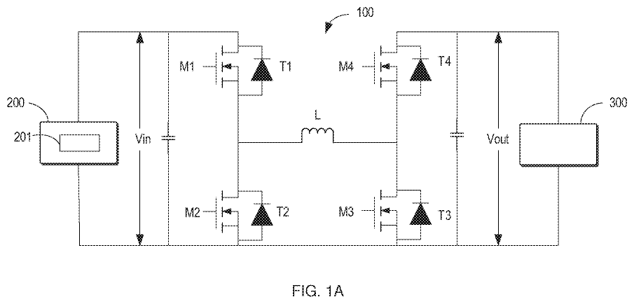

The buck-boost operating mode of the PTU will be introduced below with reference to FIGS. 1A and 1B. FIG. 1A illustrates a schematic diagram of the connection relationship between the power transmission unit, fuel cell stack, and power battery according to an example of the present disclosure.

As shown in FIG. 1A, the PTU 100 can be connected between the fuel cell stack 200 and the high-voltage battery 300 to transmit power from the fuel cell stack 200 to the high-voltage battery 300. If the PTU 100 operates in Buck-Boost mode, a non-complementary buck-boost control method is used to reduce the phase current ripple of the PTU and decrease the phase inductance value. The output voltage of the fuel cell stack 200 can be input to the PTU 100 as the input voltage Vin, and the output voltage Vout of the PTU 100 can be input to the high-voltage battery 300.

In some examples, the operating mode of the PTU 100 can depend on the magnitudes of Vin and Vout. By sampling the input voltage Vin and obtaining the voltage Vout of the high-voltage battery (for example, the control unit of the high-voltage battery may output the voltage Vout once every millisecond), the ratio of Vout/Vin is used to determine the operating mode of the PTU 100. If Vout/Vin is less than 1, the buck mode is used; if Vout/Vin is greater than 1, the boost mode is used; and if Vout/Vin is close to 1, the buck-boost mode is used to connect the buck mode and the boost mode.

As shown in FIG. 1A, the PTU 100 can include four MOS transistors M1 to M4, each of which can be an NMOS transistor. The MOS transistor M1 can also be referred to as the first switch, which is turned on and off with a first duty cycle D1; and the MOS transistor M3 can also be referred to as the second switch, which is turned on and off with a second duty cycle D3. The PTU 100 can also include diodes T1 to T4 connected between the source and drain of each MOS transistor. The MOS transistors M1 and M2 are connected in series, and the MOS transistors M3 and M4 are connected in series. The PTU 100 also includes an inductive element L, one end of which is connected between the MOS transistors M1 and M2, for example, between the source of the MOS transistor M1 and the drain of the MOS transistor M2, and the other end of which is connected between the MOS transistors M3 and M4, for example, between the source of the MOS transistor M4 and the drain of the MOS transistor M3. As shown in FIG. 1A, the drain of the MOS transistor M1 and the source of the MOS transistor M2 can be connected to the fuel cell stack 200, so that the output voltage of the fuel cell stack 200 is input to the PTU 100 as the input voltage Vin. In addition, the drain of the MOS transistor M4 and the source of the MOS transistor M3 can be connected to the high-voltage battery 300, so that the output voltage Vout of the PTU 100 is input to the high-voltage battery 300.

As shown in FIG. 1A, the fuel cell stack 200 includes a Fuel Cell Control Unit (FCCU) 201, which can be used to control the current of the fuel cell stack 200, so that its current is stabilized at a certain current value. Typically, the current of the fuel cell stack 200 in a stable state is slightly less than the current of the inductive element L in a stable state. For example, if the Fuel Cell Control Unit 201 indicates that the stable current of the fuel cell stack 200 is 20 A, then the phase current of the inductive element L in a stable state (i.e., the average current over one cycle) is approximately 25 A.

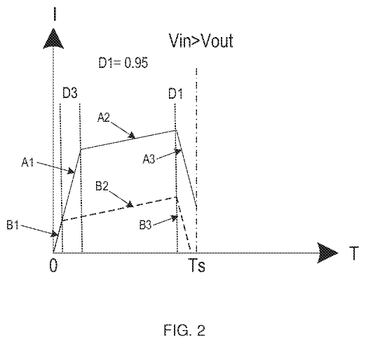

The current flowing through the inductive element L is associated with the duty cycle D1 of the MOS transistor M1 and the duty cycle D3 of the MOS transistor M3. These two duty cycles can be controlled, for example, by a controller 1, which will be described below with reference to FIG. 3, to change the current flowing through the inductive element L, i.e., to control the trend of the current change of the inductive element L (i.e., phase current or curve slope).

The current flow direction and the trend of current change when the power transmission unit of the present disclosure operates in the buck-boost mode will be described below with reference to FIG. 1B. As shown in FIG. 1B, the current in the circuit diagrams depicted in the left upper diagram (I), left middle diagram (II), and left lower diagram (III) on the left side of FIG. 1B corresponds to the three polyline segments I, II, and III within each cycle as shown in the right upper and right lower diagrams of FIG. 1B. In the right upper diagram of FIG. 1B, the case where Vin is greater than Vout is illustrated; however, in the right lower diagram of FIG. 1B, the case where Vin is less than Vout is shown.

In the example shown in FIG. 1B, as depicted in the left upper diagram (I) of FIG. 1B, during the first stage, at the initial moment of this stage, both MOSFETs M1 and M3 are turned on, and at the end of the first stage, MOSFET M3 is turned off. For example, if the duty cycle of MOSFET M3 is 0.15, then within the first cycle, at the moment corresponding to 0.15 Ts, MOSFET M3 is turned off. Therefore, in the first stage, as shown by the dashed line i1, the current flows through MOSFET M1, inductive element L, and MOSFET M3. As shown in the right upper and right lower diagrams of FIG. 1B, the current in the first stage rises with a slope of Vin/L as indicated by polyline I. Therefore, during this first stage, the current flowing through the inductive element L increases.

As depicted in the left middle diagram (II) of FIG. 1B, in the second stage, since M3 has been turned off, the circuit of inductive element L will seek another path to continue the current flow. In this second stage, MOSFET M3 is turned off and MOSFET M1 is turned on, but at the end of this second stage, MOSFET M1 is turned off. For example, if the duty cycle of MOSFET M1 is 0.95, then within the first cycle, at the moment corresponding to 0.95 Ts, MOSFET M1 is turned off. Therefore, in the second stage, as shown by the dashed line i2, the current flows through MOSFET M1, inductive element L, and diode T4 to achieve energy transfer. In this second stage, the trend of the current through inductive element L, i.e., the slope, is (Vin−Vout)/L. In the case where Vin is greater than Vout, as shown by polyline II in the right upper diagram, the slope is positive, thus the current increases; in the case where Vin is less than Vout, as shown by polyline II in the right lower diagram, the slope is negative, thus the current decreases.

As depicted in the left lower diagram (III) of FIG. 1B, in the third stage, MOSFET M1 is also turned off. To continue the current flow, as shown by the dashed line i3, the current through inductive element L flows through diode T2, inductive element L, and diode T4. In this third stage, as shown by polyline III in the right upper and right lower diagrams of FIG. 1B, the trend of the current through inductive element L, i.e., the descending slope, is (−Vout)/L. Therefore, in this stage, the current flowing through inductive element L decreases.

When the Power Transmission Unit (PTU) operates in the buck-boost mode, the duty cycles D3 of MOSFET M3 and D1 of MOSFET M1 are different, typically with the duty cycle D3 of MOSFET M3 being smaller than the duty cycle D1 of MOSFET M1, meaning that MOSFET M3 turns off earlier than MOSFET M1, as shown in FIG. 1B. In some techniques, to simplify the duty cycle contribution calculation, the duty cycle D1 of MOSFET M1 can be set to a constant 0.95, and the phase current (i.e., the slope of the current curve or the value obtained by dividing the area under the current curve by the cycle time) can be adjusted by changing the duty cycle D3 of MOSFET M3. When Vout/Vin approaches the switching threshold, hysteresis calibration is performed to switch between multiple modes to avoid unnecessary frequent switching.

When Vin is higher than Vout and the Fuel Cell Control Unit (FCCU) 201 requires small current control (i.e., to make the indicated current of the fuel cell stack small, or the average value of the current through inductive element L or the phase current is small), for example, below 20 A, based on traditional techniques, there is a risk of being unable to control small currents in the fuel cell stack 200. Because even if the duty cycle D3 of MOSFET M3 is close to 0, but the duty cycle D1 of MOSFET M1 remains at 0.95, then when MOSFET M1 turns off (i.e., at the moment corresponding to 0.95 Ts), a high current (e.g., 70 A to 80 A) will still be reached, resulting in the instantaneous average current of inductive element L within one cycle being much greater than the indicated 20 A, thus failing to achieve small current control in the fuel cell stack 200.

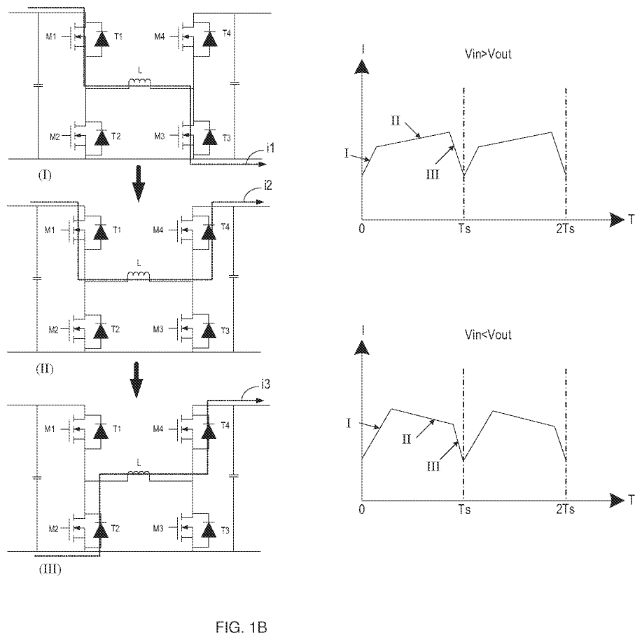

FIG. 2 illustrates an example of the instantaneous current variation trends of the inductive element L in Continuous Current Mode (CCM) (solid line) and Discontinuous Current Mode (DCM) (dashed line).

As shown by the solid line in the example of FIG. 2, when Vin is greater than Vout, and the PTU operates in Continuous Current Mode, during one cycle (from time 0 to time Ts), before the MOS transistor M3 turns off (at the time corresponding to the duty cycle D3), the current of the inductive element L rises along the first segment A1; before the MOS transistor M1 turns off (at the time corresponding to the duty cycle D1), the current of the inductive element L rises along the first segment A2; after the MOS transistor M1 turns off, the current of the inductive element L decreases along the third segment A3, with the end current of the first cycle being higher than the starting current of the first cycle. In the second cycle (i.e., from time Ts to 2 Ts), the instantaneous current on the inductive element L continues to increase from the end current of the first cycle along a curve similar to that of the first cycle (not shown). When the phase current (i.e., the envelope area of the curve/period time) approaches the high current indicated by the FCCU 201, the starting current and the ending current of the inductive element L in a certain cycle will be substantially the same and stabilize at that value to achieve stable current control of the fuel cell stack.

As shown by the dashed line in the example of FIG. 2, when Vin is greater than Vout, and the PTU operates in Discontinuous Current Mode, during the first cycle (from time 0 to time Ts), before the MOS transistor M3 turns off, the current of the inductive element L rises along the first segment B1; before the MOS transistor M1 turns off, the current of the inductive element L rises along the second segment B2; after the MOS transistor M1 turns off, the current of the inductive element L decreases along the third segment B3. However, compared to Continuous Current Mode, because the duty cycle of the MOS transistor M3 is smaller, the current value at the peak of the first segment B1 is less than the current value at the peak of the first segment A1, and the same applies to segment B2. Thus, before the end of the first cycle, the current on the inductive element L decreases to 0 along segment B3. For this Discontinuous Current Mode, the phase current on the inductor (i.e., the envelope area of the curve/period time) is smaller than the phase current in Continuous Current Mode, thus allowing control of smaller currents compared to Continuous Current Mode.

In traditional technology, since the duty cycle D3 of the MOS transistor M3 is greater than 0, the current flowing through the inductive element L increases sharply during the conduction period of the MOS transistor M3. When Vin is greater than Vout, after the MOS transistor M3 turns off, the current continues to increase until the time corresponding to a duty cycle of 0.95 (i.e., the time of 0.95 Ts), and then decreases. As can be seen from FIG. 2, even if the current of the inductive element L varies in Discontinuous Current Mode, the envelope of the current variation curve produces a larger area within the first cycle. In subsequent cycles, even if the duty cycle D3 of the MOS transistor M3 becomes 0, because the duty cycle D1 of the MOS transistor M1 remains fixed at 0.95, a triangular envelope is still generated, with the peak of the envelope located at the time of 0.95 Ts in the corresponding cycle. Even if the duty cycle D3 becomes 0, the current at the peak (e.g., 70 A) is greater than or much greater than the small current indicated by the fuel cell stack control unit FCCU 201 (e.g., less than 20 A), so the area of the generated triangular envelope divided by Ts results in a phase current far greater than the small current indicated by the FCCU 201, thus failing to achieve small current control.

Therefore, in some technologies, even when using DCM and adjusting D3 to 0, the instantaneous current of the inductive element L within that cycle may still reach a value much greater than the indicated current (e.g., 20 A or below) (e.g., 70 A or above), thus the average current (i.e., phase current) calculated by the envelope area is also far greater than the small current of 20 A. Therefore, in these technologies, even using Discontinuous Current Mode and adjusting D3 to zero, small current control cannot be achieved.

To this end, examples of the present disclosure propose a new method of distributing the duty cycle. The structure of the controller 1 of the power transmission unit 100 according to an example of the present disclosure will be described below with reference to FIG. 3. The controller 1 can implement the new method of distributing the duty cycle.

According to an example of the present disclosure, the controller 1 can dynamically determine the total duty cycle Dtotal of the duty cycle D1 of the MOS transistor M1 and the duty cycle D3 of the MOS transistor M3 based on the desired phase current and the actual phase current of the inductive element L, and dynamically adjust D1 and D3 based on the determined total duty cycle Dtotal, such that D1 and D3 dynamically decrease. Continue to control the MOS transistor M1 and the MOS transistor M3 based on the reduced D1 and D3 so that the instantaneous current on the inductive element L further decreases, thereby reducing the Dtotal determined by the controller 1, and further reducing D1 and D3 until D3 decreases to zero, and D1 also decreases to an appropriate value. In some examples, D3 can be reduced to zero first, and then D1 is continuously adjusted to decrease until D1 decreases to an appropriate value.

In some examples, the phase current is the average current within one cycle, i.e., the average current obtained by dividing the envelope area of the instantaneous current curve on the inductive element L by the period time. In some examples, the period time is 32 μs, and it is unlikely to collect the instantaneous current of each us, so the instantaneous current on the inductive element L is sampled every 4 μs within the period, and then the average value of the 8 sampling values is taken as the measured phase current of the inductive element L.

In some examples, the controller 1 determines the desired phase current iphase_DC* of the inductive element L based on the desired stack current istack* and the actual stack current istack_act. The desired stack current is specified by the FCCU 201. When performing small current control, the desired stack current specified by the FCCU 201 can be, for example, less than or equal to 20 A. When performing high current control, the desired stack current specified by the FCCU 201 can be, for example, greater than or equal to 200 A. The actual stack current is also obtained by sampling and averaging.

As shown in FIG. 3, the controller 1 may include a first closed-loop circuit 10, which receives the desired stack current istack* from the FCCU 201 and the actual stack current i_stack_act measured from the battery stack 200, thereby performing proportional-integral control based on these two inputs to obtain the desired phase current iphase_DC*, which can be a direct current. As shown in FIG. 3, the controller 1 may also include a second closed-loop circuit 20, which receives the actual phase current iphase_act measured from the inductive element L and the desired phase current iphase_DC* output from the first closed-loop circuit 10 to calculate the total duty cycle Dtotal, wherein the actual phase current iphase_act is obtained using sampling and averaging as described above.

In one example, as shown in FIG. 3, the first closed-loop circuit 10 may respectively include a first comparator 11 and a first proportional-integral (PI) controller 12. The first comparator 11 can receive the desired stack current istack* and the actual stack current i_stack_act, and the output of the first comparator 11 is input to the first PI controller 12, so that the first closed-loop circuit 10 outputs the desired phase current iphase_DC *. The second closed-loop circuit 20 may respectively include a second comparator 21 and a second PI controller 22. The second comparator 21 receives the desired phase current iphase_DC* and the actual phase current iphase_act, and the output of the second comparator 21 is input to the second PI controller 22, so that the second closed-loop circuit 10 outputs the total duty cycle Dtotal.

As shown in FIG. 3, the current control structure of the PTU 100 includes two closed loops. The outer closed loop is the stack current closed loop, which has inputs of the stack current istack* received from the FCCU 201 and the actual stack current i_stack_act measured from the battery stack, and its output is the desired phase current iphase_DC *. The inner closed loop is the inductive phase current closed loop, which has inputs of the actual phase current iphase_act measured from the inductive element L and the desired phase current iphase_DC* output from the first closed-loop circuit 10, and its output is Dtotal. The outer closed loop is used to eliminate the steady-state error in the stack current.

Continuing to refer to FIG. 3, the controller 1 further includes a duty cycle adjustment circuit 30, which adjusts and allocates D1 and D3 based on the determined total duty cycle Dtotal, such that both D1 and D3 are reduced. The reduced D1 and D3 are then used to continue controlling MOSFET M1 and MOSFET M3, respectively, so that the current on the inductive element L associated with the duty cycles D1 and D3 also changes accordingly. In some examples, the value of D1 can be determined based on the total duty cycle Dtotal, and then the value of D3 can be set based on the total duty cycle Dtotal and D1.

In some examples, when the total duty cycle Dtotal determined by the second closed-loop circuit 20 is greater than or equal to 0.95, the duty cycle adjustment circuit 30 can set D1 to 0.95 and D3 to Dtotal −0.95. In the case of small current control, the current given by the FCCU 201 is less than the current at present, so the desired phase current will be less than the current actual phase current, and thus the total duty cycle determined by the second closed-loop circuit 20 will be in a decreasing trend. The aforementioned two closed loops will continuously reduce Dtotal, which can be reduced from an initial value greater than or equal to 0.95 (e.g., approximately 1.1) to less than 0.95. When the Dtotal determined by the second closed-loop circuit 20 is less than 0.95, D1 can be set to the newly determined Dtotal, so that D1 is less than the initially set fixed value (i.e., 0.95), which means the on-time of MOSFET M1 becomes shorter, and D3 is set to 0, which means MOSFET M3 will be in an off state.

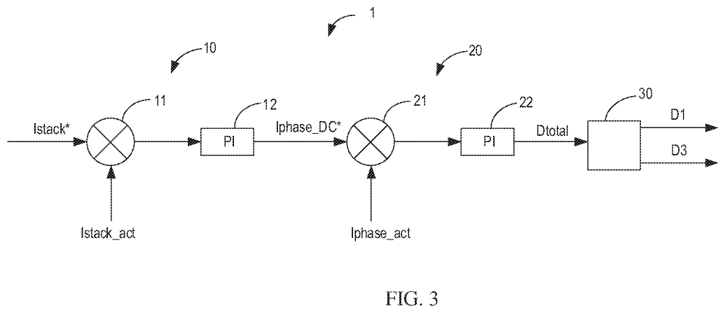

Below, with reference to FIG. 4, an example of the instantaneous current variation trend on the inductive element L in the buck-boost mode and when Vin>Vout according to an example of the present disclosure will be described.

Referring to the example in FIG. 4, after the FCCU 201 gives small current control, the inductive element L will choose to operate in the discontinuous current mode rather than the continuous current mode. In the first cycle, since the determined Dtotal is still greater than 0.95, for example, 1.1, the duty cycle adjustment circuit 30 will set D1 to 0.95 and D3 to 1.1−0.95=0.15. Then, in the first cycle, before 0.15 Ts, the instantaneous current of the inductive element L increases with a slope of Vin/L. At the moment of 0.15 Ts, D3 is turned off, and the instantaneous current of the inductive element L will flow through the diode T4 next to MOSFET M4. Since Vin is greater than Vout, the current will increase with a slope of (Vin−Vout)/L until the moment of 0.95 Ts. At the moment of 0.95 Ts, D1 is turned off, and the instantaneous current of the inductive element L will flow through diodes T2 and T4, and the instantaneous current of the inductive element L will decrease with a slope of −Vout/L to 0. In some examples, the moment when the current of the inductive element L drops to 0 will be earlier than the end of the cycle.

As shown in FIG. 4, for ease of explanation, it is assumed that in the second cycle, Dtotal decreases from the initial 1.1 to 1, so D1 will continue to be fixed at 0.95, and thus D3 will be equal to 0.05. Compared to the current envelope of the first cycle, the current envelope area of the second cycle is reduced.

Since FCCU 201 provides small current control, in a cycle after the first cycle, Dtotal decreases to 0.95. For ease of explanation, as shown in FIG. 4, it is assumed that in the third cycle, Dtotal decreases to 0.95. At this time, Dtotal is still greater than or equal to 0.95, and the duty cycle adjustment circuit 30 still sets D1 to a fixed value of 0.95, but at this time D3 will be equal to 0. As shown in FIG. 4, in the third cycle, at the starting point of the cycle, D3 is turned off, so the current starts to rise from the starting point of the cycle at a slope of (Vin−Vout)/L until 0.95 Ts. At 0.95 Ts, D1 is turned off, and the instantaneous current of the inductive element L will drop to 0 at a slope of −Vout/L. By comparing the current envelope areas of the inductive element L in the second and third cycles, it can be seen that the envelope area of the third cycle is smaller than that of the second cycle, which means that the phase current of the inductive element L further decreases over time.

Since FCCU 201 provides small current control, in an appropriate cycle, Dtotal decreases to below 0.95. For ease of explanation, as shown in FIG. 4, it is assumed that in the fourth cycle, Dtotal decreases to below 0.95, for example, 0.85. Since the determined Dtotal decreases to below 0.95, the duty cycle adjustment circuit 30 sets D1 to Dtotal, i.e., 0.85, and sets D3 to 0. As shown in FIG. 4, in the fourth cycle, at the starting point of the cycle, D3 is turned off, so the current starts to rise from the starting point of the cycle at a slope of (Vin−Vout)/L until 0.85 Ts. At 0.85 Ts, D1 is turned off, and the instantaneous current of the inductive element L will drop to 0 at a slope of −Vout/L. By comparing the current envelope areas of the inductive element L in the third and fourth cycles, it can be seen that the envelope area of the fourth cycle is smaller than that of the third cycle, which means that the phase current of the inductive element L further decreases over time.

Since FCCU 201 provides small current control, in an appropriate cycle, Dtotal decreases to an appropriate value, resulting in a smaller current envelope area in that cycle, and the calculated phase current approaches the indicated small current (e.g., 20 A or even smaller such as 5 A). For ease of explanation, as shown in FIG. 4, it is assumed that in the fifth cycle, Dtotal decreases to 0.74, then D1 is set to Dtotal, i.e., 0.74, and D3 is set to 0. By comparing the current envelope areas of the inductive element L in the fifth and fourth cycles, it can be seen that the envelope area of the fifth cycle is smaller than that of the fourth cycle, which means that the phase current of the inductive element L further decreases over time, so that the calculated phase current can approach the indicated small current (e.g., 20 A or even smaller such as 5 A).

Therefore, in the case where Vin is greater than Vout, in the buck-boost mode, the small current control indicated by FCCU 201 can be achieved by the new method of distributing the duty cycles D1 and D3 according to the present disclosure.

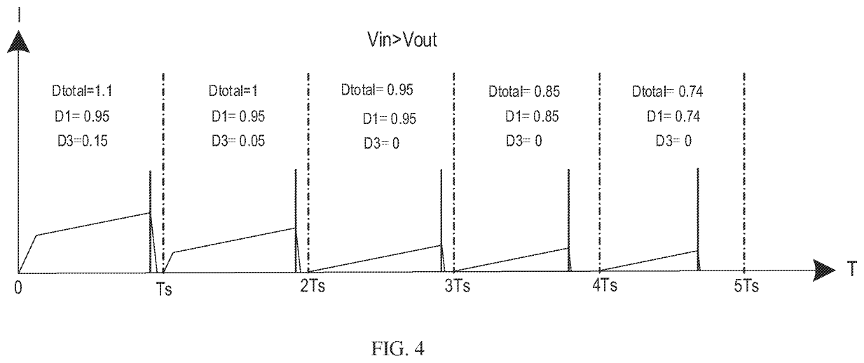

Below, with reference to FIG. 5, an example of the instantaneous current variation trend on the inductive element L in the buck-boost mode and when Vin>Vout according to an example of the present disclosure will be described.

Referring to the example of FIG. 5, after FCCU 201 provides small current control, the inductive element L will choose to operate in the discontinuous current mode. In the first cycle, since the determined Dtotal is still greater than 0.95, for example, 1.1, the duty cycle adjustment circuit 30 will set D1 to 0.95 and D3 to 1.1−0.95=0.15. As shown in FIG. 5, in the first cycle, before 0.15 Ts, the instantaneous current of the inductive element L increases with a slope of Vin/L. At the moment of 0.15 Ts, D3 is turned off, and the instantaneous current of the inductive element L will flow through the diode T4 next to MOSFET M4. Since Vin is less than Vout, the current will decrease with a slope of (Vin−Vout)/L until the moment of 0.95 Ts. At the moment of 0.95 Ts, D1 is turned off, and the instantaneous current of the inductive element L will flow through diodes T2 and T4, and the instantaneous current of the inductive element L will decrease with a slope of −Vout/L to 0. In some examples, the moment when the current of the inductive element L drops to 0 will be earlier than the end of the cycle.

As shown in FIG. 5, for ease of explanation, it is assumed that in the second cycle, Dtotal decreases from the initial 1.1 to 1, so D1 will continue to be fixed at 0.95, and thus D3 will be equal to 0.05. Compared to the current envelope of the first cycle, the current envelope area of the second cycle is reduced.

Since FCCU 201 provides small current control, in a cycle after the first cycle, Dtotal decreases to slightly greater than 0.95, such as 0.97. For ease of explanation, as shown in FIG. 5, it is assumed that in the third cycle, Dtotal decreases to 0.97. At this time, Dtotal is still greater than or equal to 0.95, and the duty cycle adjustment circuit 30 still sets D1 to a fixed value of 0.95, so D3 will be 0.02. As shown in FIG. 5, in the third cycle, the current starts to rise from the starting point of the cycle at a slope of Vin/L until 0.02 Ts. At 0.02 Ts, D3 is turned off, and the instantaneous current of the inductive element L will drop to 0 at a slope of (Vin−Vout)/L. Before reaching 0.95 Ts, the current of the inductive element L has already dropped to 0. By comparing the current envelope areas of the inductive element L in the second and third cycles, it can be seen that the envelope area of the third cycle is much smaller than that of the second cycle, which means that the phase current of the inductive element L further decreases over time.

Since FCCU 201 provides small current control, in an appropriate cycle, Dtotal decreases to 0.95. For ease of explanation, as shown in FIG. 5, it is assumed that in the fourth cycle, Dtotal decreases to 0.95. At this time, D3 will be set to 0. As shown in FIG. 5, in the fourth cycle, at the starting point of the cycle, D3 is turned off, so the current starts at 0 from the starting point of the cycle, thus achieving zero current control.

Therefore, compared to the case where Vin is greater than Vout, in the case where Vin is less than Vout, small current control can be achieved more quickly, and even zero current control can be achieved. When Dtotal decreases to close to 0.95, zero current control can already be achieved without needing Dtotal to continue to decrease, for example, without needing to decrease Dtotal to 0.74 as in the case where Vin is greater than Vout, but only needing to decrease D1 to close to 0.95 and D3 to close to 0.

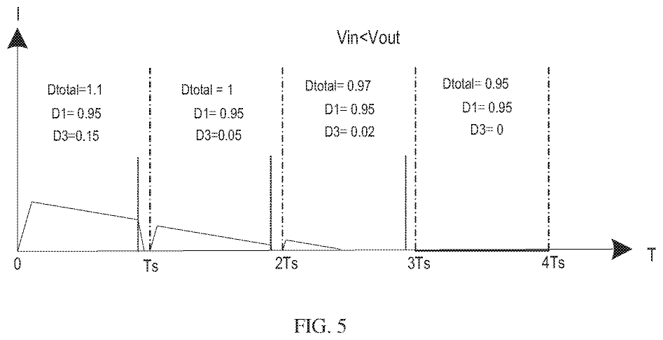

The following describes a method 600 for controlling the current of a power transmission unit according to an example of the present disclosure, with reference to FIG. 6. The power transmission unit may be the power transmission unit 100 shown with reference to FIG. 1, which may include a controller 1 as shown in FIG. 3. The method for controlling the current of the power transmission unit is executed by the controller 1. The power transmission unit 100 may include MOSFET M1 (also referred to as the first switch, which is turned on and off with a first duty cycle) and MOSFET M3 (also referred to as the second switch, which is turned on and off with a second duty cycle). Additionally, the power transmission unit 100 may include an inductive element L, which is connected between the first switch and the second switch, and the current flowing through it is associated with the first duty cycle and the second duty cycle. In other words, different settings of the first duty cycle and the second duty cycle will affect the current of the inductive element L, as described above with reference to FIGS. 4 and 5. As shown in FIG. 6, in block 610, the desired phase current for the inductive element L is obtained. In some examples, the desired phase current is output by the first closed-loop circuit 10 (i.e., the outer loop) of the controller 1, which receives the desired stack current and the measured stack current.

In block 620, the actual phase current flowing through the inductive element L is obtained. In some examples, the actual phase current flowing through the inductive element L can be obtained by sampling the instantaneous current flowing through the inductive element L multiple times within one cycle and averaging the sampled currents.

In block 630, based on the desired phase current and the actual phase current, the total duty cycle Dtotal, which is the sum of the duty cycle D1 of MOSFET M1 and the duty cycle D2 of MOSFET M2, is determined. In some examples, the second closed-loop circuit 20 of the controller 1 receives the desired phase current and the actual phase current of the inductive element L and determines the total duty cycle Dtotal based on both.

In block 640, the duty cycle D1 of MOSFET M1 and the duty cycle D2 of MOSFET M2 are adjusted based on the total duty cycle. In some examples, in response to the determined total duty cycle being greater than or equal to 0.95, the duty cycle adjustment circuit 30 of the controller 1 sets the duty cycle D1 of MOSFET M1 to 0.95 and the duty cycle D3 of MOSFET M3 to the total duty cycle minus 0.95; and in response to the determined total duty cycle being less than 0.95, the duty cycle adjustment circuit 30 sets the duty cycle D1 of MOSFET M1 to the total duty cycle and the duty cycle D3 of MOSFET M3 to zero.

In block 650, MOSFET M1 is turned on and off based on the adjusted duty cycle D1, and MOSFET M3 is turned on and off based on the adjusted duty cycle D3, to control the current flowing through the inductive element L. In the case where the FCCU 201 of the fuel cell stack provides small current control, the total duty cycle will show a gradually decreasing trend. When the total duty cycle is greater than or equal to 0.95, the duty cycle D1 is set to 0.95, and the duty cycle D3 decreases as the total duty cycle decreases, since it equals the total duty cycle minus 0.95, until it reaches zero. When the duty cycle decreases to less than 0.95, D1 is set to the total duty cycle, so D1 will also decrease as the total duty cycle decreases, until it reaches an appropriate value, making the actual measured desired current of the inductive element L approach the small current specified by FCCU 201 (i.e., the desired stack current).

Therefore, the method 600 for controlling the current of the power transmission unit according to the present disclosure can achieve the smaller desired stack current specified by FCCU 201, and can even meet current demands of less than 5 A, thus eliminating blind spots in current control. The power transmission unit 100 and the method 600 for controlling the current of the power transmission unit can be easily implemented in existing software, with no negative current on the stack side, and remain compatible with previous control strategies in high current regions.

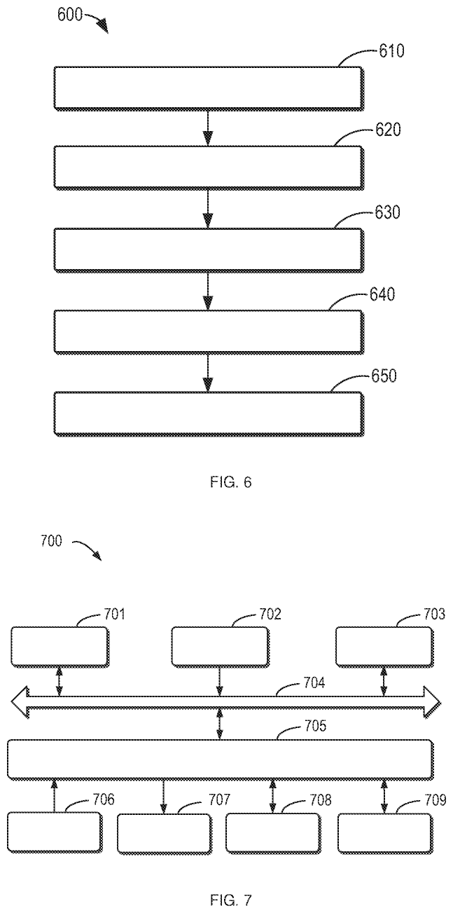

FIG. 7 shows a schematic block diagram of an example apparatus 700 that can be used to implement examples of the present disclosure. As shown, the apparatus 700 includes a computing unit 701, which can perform various appropriate actions and processes according to computer program instructions stored in a read-only memory (ROM) 702 or loaded into a random-access memory (RAM) 703 from a storage unit 708. Various programs and data required for the operation of the apparatus 700 can also be stored in the RAM 703. The computing unit 701, ROM 702, and RAM 703 are interconnected via a bus 704. An input/output (I/O) interface 705 is also connected to the bus 704.

Multiple components in the apparatus 700 are connected to the I/O interface 705, such as: an input unit 706, such as a keyboard, mouse, etc.; an output unit 707, such as various types of displays, speakers, etc.; a storage unit 708, such as disks, optical discs, etc.; and a communication unit 707, such as network cards, modems, wireless communication transceivers, etc. The communication unit 707 allows the apparatus 700 to exchange information/data with other devices via computer networks such as the Internet and/or various telecommunication networks.

The computing unit 701 can be various general-purpose and/or special-purpose processing components with processing and computing capabilities. Examples of the computing unit 701 include, but are not limited to, central processing units (CPU), graphics processing units (GPU), various dedicated artificial intelligence (AI) computing chips, various computing units running machine learning model algorithms, digital signal processors (DSP), and any appropriate processors, controllers, microcontrollers, etc. The computing unit 701 executes the various methods and processes described above, such as method 600. For example, in some examples, method 600 can be implemented as a computer software program tangibly contained in a machine-readable medium, such as the storage unit 708. In some examples, parts or all of the computer program can be loaded and/or installed onto the apparatus 700 via the ROM 702 and/or the communication unit 707. When the computer program is loaded into the RAM 703 and executed by the computing unit 701, one or more steps of the method 600 described above can be performed. Alternatively, in other examples, the computing unit 701 can be configured to perform method 600 by any other suitable means (e.g., by means of firmware).

The functions described above herein can be performed, at least in part, by one or more hardware logic components. For example, and without limitation, exemplary types of hardware logic components that can be used include: Field Programmable Gate Arrays (FPGA), Application Specific Integrated Circuits (ASIC), Application Specific Standard Products (ASSP), System on a Chip (SOC), Complex Programmable Logic Devices (CPLD), and the like.

The program code for implementing the methods of the present disclosure can be written in any combination of one or more programming languages. This program code can be provided to a processor or controller of a general-purpose computer, special-purpose computer, or other programmable data processing apparatus such that the program code, when executed by the processor or controller, causes the functions/operations specified in the flowcharts and/or block diagrams to be implemented. The program code can be executed entirely on the machine, partly on the machine, as a stand-alone software package partly on the machine and partly on a remote machine, or entirely on a remote machine or server.

In the context of the present disclosure, a machine-readable medium can be a tangible medium that can contain or store programs for use by or in conjunction with an instruction execution system, apparatus, or device. A machine-readable medium can be a machine-readable signal medium or a machine-readable storage medium. The machine-readable medium can include, but is not limited to, electronic, magnetic, optical, electromagnetic, infrared, or semiconductor systems, apparatuses, or devices, or any suitable combination of the foregoing. More specific examples of the machine-readable storage medium would include electrical connections based on one or more wires, portable computer disks, hard disks, random access memory (RAM), read-only memory (ROM), erasable programmable read-only memory (EPROM or Flash memory), optical fibers, portable compact disc read-only memory (CD-ROM), optical storage devices, magnetic storage devices, or any suitable combination of the foregoing. Furthermore, although operations have been depicted in a specific order, it should be understood that such operations are not required to be performed in the specific order shown or in sequential order, nor are all illustrated operations required to be performed to achieve the desired results. In certain contexts, multitasking and parallel processing may be advantageous. Similarly, although several specific implementation details are included in the above discussion, these should not be construed as limiting the scope of the present disclosure. Certain features described in the context of separate examples can also be implemented in combination in a single implementation. Conversely, various features described in the context of a single implementation can also be implemented separately or in any suitable sub-combination in multiple implementations.

Although the subject matter has been described in language specific to structural features and/or methodological acts, it is to be understood that the subject matter defined in the appended claims is not necessarily limited to the specific features or acts described above. Rather, the specific features and operations described above are merely exemplary forms of implementing the claims.

What is claimed is:

1. A power transmission unit for transmitting electromotive force of a fuel cell stack to a power battery, comprising:
a first switch configured to turn on and off at a first duty cycle;
a second switch configured to turn on and off at a second duty cycle less than the first duty cycle;
an inductive element connected between the first switch and the second switch, through which a current flows that is associated with the first duty cycle and the second duty cycle; and
a controller configured to determine a total duty cycle as the sum of the first duty cycle and the second duty cycle based on an actual phase current and a desired phase current of the inductive element, and to adjust the first duty cycle and the second duty cycle based on the determined total duty cycle.

2. The power transmission unit according to claim 1, wherein the controller is further configured to determine the desired phase current based on a desired stack current and an actual stack current.

3. The power transmission unit according to claim 2, wherein the stack further comprises a stack control unit configured to provide the desired stack current.

4. The power transmission unit according to claim 1, wherein adjusting the first duty cycle and the second duty cycle based on the determined total duty cycle comprises:
setting the first duty cycle to 0.95 and the second duty cycle to the total duty cycle minus 0.95 in response to the determined total duty cycle being greater than or equal to 0.95; and
setting the first duty cycle to the total duty cycle and the second duty cycle to zero in response to the determined total duty cycle being less than 0.95.

5. The power transmission unit according to claim 1, wherein the controller comprises:
a first closed-loop circuit to which the desired stack current and the actual stack current are input to determine the desired phase current; and
a second closed-loop circuit to which the actual phase current and the desired phase current are input to determine the total duty cycle.

6. The power transmission unit according to claim 1, wherein the input voltage from the stack to the power transmission unit is greater than the output voltage to the power battery.

7. The power transmission unit according to claim 3, wherein the power transmission unit operates in a non-complementary buck-boost mode, and the stack control unit is configured to provide the desired stack current of up to 20 amperes.

8. The power transmission unit according to claim 1, wherein the controller is further configured to: sample the current flowing through the inductive element multiple times within a cycle and calculate the average of the sampled currents as the actual phase current.

9. A method for controlling the current of a power transmission unit, the power transmission unit being used to transmit electromotive force of a fuel cell stack to a power battery, the power transmission unit comprising: a first switch configured to turn on and off at a first duty cycle; a second switch configured to turn on and off at a second duty cycle; and an inductive element connected between the first switch and the second switch, through which a current flows that is associated with the first duty cycle and the second duty cycle, the method comprising:
obtaining a desired phase current for the inductive element;
obtaining an actual phase current flowing through the inductive element;
determining the total duty cycle as the sum of the first duty cycle and the second duty cycle based on the desired phase current and the actual phase current;
adjusting the first duty cycle and the second duty cycle based on the total duty cycle; and
controlling the turning on and off of the first switch based on the adjusted first duty cycle and controlling the turning on and off of the second switch based on the adjusted second duty cycle to control the current flowing through the inductive element.

10. The method according to claim 9, wherein obtaining the desired phase current for the inductive element comprises:
determining the desired phase current for the inductive element based on a desired stack current and an actual stack current.

11. The method according to claim 9, wherein measuring the actual phase current flowing through the inductive element comprises:
sampling the current flowing through the inductive element multiple times within a cycle and calculating the average of the sampled currents as the actual phase current.

12. The method according to claim 9, wherein adjusting the first duty cycle and the second duty cycle based on the total duty cycle comprises:
setting the first duty cycle to 0.95 and the second duty cycle to the total duty cycle minus 0.95 in response to the determined total duty cycle being greater than or equal to 0.95; and
setting the first duty cycle to the total duty cycle and the second duty cycle to zero in response to the determined total duty cycle being less than 0.95.

13. A fuel cell system, comprising:
a fuel cell stack;
a power battery; and
the power transmission unit according to claim 1, configured to transmit the electromotive force of the fuel cell stack to the power battery.

14. A machine-readable storage medium storing machine-executable instructions, wherein the machine-executable instructions are executed by a processor to implement the method according to claim 9.
